(19) United States
(12) Patent Application Publication
(10) Pub. No.: US 2004/0253043 A1
(43) Pub. Date: Dec. 16, 2004

(54) Writing pen with built-in facility for creating an embossed and metallic coated surface under-layer for signature, to secure originality

(76) Inventor: Chenicheri Vadakkil Venugopalan, Karnataka (IN)

Correspondence Address: FOLEY AND LARDNER, SUITE 500, 3000 K STREET NW, WASHINGTON, DC, 20007, US

(21) Appl. No.: 10/477,737

(22) PCT Filed: Apr. 17, 2003
(86) PCT No.: PCT/IN03/00162

(30) Foreign Application Priority Data
Apr. 18, 2002 (IN) 300/MAS/2002

(51) Int. Cl. B43M 11/02; B05C 17/02

(52) U.S. Cl. 401/208

(57) ABSTRACT

This invention relates to a writing Pen with built-in facility to create an embossed and metallic coated under-layer for signature, to secure originality. The pen is provided at the rear end with roller cartridge arrangement in the form of a cartridge, which is attached/connected in any conventional manner to the body of the pen. This cartridge houses the coating substance in a replaceable sub-cartridge and a roller arrangement. The coating substance is a paste made of metal such as gold, which has appropriate qualities to ensure quick drying, non-peeling, clarity and compatibility with ink signature and is provided in a container in the form of a replaceable sub cartridge inside the main cartridge. The main cartridge is a cylinder made of suitable material housing an assembly of embossing cum coating roller arrangement and a means to store and uniformly supply the coating substance to the coating roller. The replaceable cartridge is a cylinder made of suitable substance of suitable dimensions to be attached in any conventional form inside the main cartridge and to store the coating substance. The roller arrangement consists of a main embossing and metal coating roller, an intermediate roller and an out feeding roller situated in the cartridge such that they are in radial contact in succession. The main embossing and metal coating roller is made of wear resistant hard material with characters or symbols engraved on the periphery and comes in contact with the paper to create miniature embossed symbols or character. The intermediate roller is made of flexible material such as Vulcan rubber, which transfers the coating substance from the out feeding roller to the main embossing and metal coating roller uniformly. The out feeding roller is made of a suitable metal, which transfers the coating substance from the replaceable sub cartridge to the intermediate roller.

This invention relates to Writing Pen having a built-in facility by the use of which it will be possible to create a special background layer of thin metallic paste (Example—Gold paste) along with miniature embossed symbols (Example—company logo) on paper, so that this Under-layer will be used as a background for Signature, by simply signing over it in the normal way by use of the pen.

When a signature has this background of say gold along with miniature Embossing on the same it will prove the Originality of the signature, because even the most advanced colour photo-copying or any other advanced scanning or other method cannot reproduce the signature with exactly the same background, as the correct golden colour of actual gold metallic paste will not be reproduced and the miniature embossed symbols etc will appear in contrast to the other portions of this background layer, taking into consideration any reproduction method has to use light reflected of the original surface and such will show Embossed portions in contrast as light gets scattered differently compared to rest of the plain surface. This background changes will-not prevent the exact reproduction of the actual signature on the original signed using a normal writing pen, thus ensuring clarity of the signature in all reproduced copies.

This invention achieves the above mentioned additional built-in facility by incorporating a metal cartridge assembly consisting of several parts into the non-used end of the body of a standard writing pen. This cartridge has a cap which when removed will expose a roller which will be used to apply the above-mentioned under-layer on any paper. Once this layer is applied on paper as desired, the cap is put back, the other end of the pen which is similar to any standard pen is used in the normal way to sign on this pre-prepared layer.

This results in guaranteeing the security of the original signature, which in turn will guarantee the originality of the document carrying this signature, whenever and wherever copies of the original are made by any of the several advanced copying methods available.

Additionally this background could also be used to write over them any critical information, which needs to be secured from being altered and copied in the case of any Document or letter (Example—Value of an Item, Delivery Date, Time etc.)

One of the main objects of this invention is to provide people wish a simple and easy method by which both the sender and the receiver of a written communication can ensure the authenticity and correctness of such information in spite of the possibility of malpractices and misrepresentation increasing with more and more advancements being made in the technology of reproduction of written communication.

In this digital age to make optimum use of IT revolution, it will become imperative sooner than later for every one to think global and make maximum use of the existing and future developments expected in the field of facilities such as internet, e-commerce, e-business, e-governance, e-banking etc., etc.,

One of the basic requirements for the above will be for an individual to have a foolproof Global Identity, which is possible only by assigning a definite 15-digit number by a single global source.

(The roller described in this invention can accommodate 16 digits)

Once the number is assigned there will be need for the individual to reproduce this exact number in each and every one of his dealings with the society, there must be a absolutely fool-proof method to ensure this, specially keeping in mind that it will be impossible for any one to reproduce this number exactly every time from memory.

(The above-described invention having the engraved roller built into the writing pen ensures this)

Another aspect to be absolutely made sure is that the above mentioned 15 digit Global identity of an individual will be used only by that particular individual and by no-one else, intentionally or otherwise.

(Global ID can become Valid only when it is in combination with the individual's super imposed signature, The mentioned invention having both the pen and the roller arrangement facilitates this.)

Another aspect to be ensured is that First hand reproduction of this global identity by the individual shall be distinctly different from any copy of the same made by use of any presently available or future copying/scanning techniques.

(With the use of the mentioned invention the originals as well as the copies will them-selves proclaim as original or copy)

Another aspect to be ensured is that there is a foolproof possibility of scanning by electronic means the 15 digits Global Identity without any ambiguity whatsoever.

Repeated embossed impressions of the Global ID on pre-determined standard gold background is possible by using the said invention

It can be fore seen that this invention, Writing Pen with built-in facility to create an embossed and metallic coated under-layer for signature, to secure originality can become a very effective tool for empowering the digital revolution.

### BACKGROUND AND PRIOR ART

As technology connected with photocopying/scanning and other means of reproduction of original documents is continuously advancing many attempts have been made in several ways to differentiate the original from their reproduction in one form or other.

Most of the approaches aims at various methods of printing on paper by using special Inks or printing using heat sensitive invisible ink words such as “void” or “copy” on the original which will show-up on the copies when reproduced, making use of light Gray ink to print certain portions on the document so that the contrast with the white Paper background is so less it is not possible to be picked-up in a copy when reproduced,(Note—in this case a person receiving a copy and who has never seen the original will not be in a position to comprehend what is actually missing to identify it as original or a copy) Some use reflective inks which distort light in several directions so the copies will not be legible etc in other words most serve the purpose by creating a situation where the whole document or a part on it cannot be copied.

Taking into consideration that any document is a written communication originating from a person to another person or persons (from 2 persons to a million people or more!) and the main purpose of a document is to convey a message from the originator to the Person or persons receiving the message.

Naturally the more the number persons the message is addressed to, more copies of the documents need to be made and if this is not possible by simple means such as photocopying the very purpose of the documents gets negated. (Here it should be mentioned that the very proliferation of photocopying and more and more advance systems coming into the market itself is proof that documents needs to be copied with all its contents as clearly as possible to serve its main purpose)

Now coming to the important features of any document, it should be addressed to some one, it should have some message/information and IT MUST HAVE A SIGNATURE of the ORIGINATOR.

The value of any document even though it may appear to be in its content and the purpose it is meant to serve, a deeper understanding will clearly show that whatever Important content it may have the IMPORTANCE really is imparted to the document only on it being SIGNED by the originator and significantly the SIGNATURE is What superimposes the Authority/Power/wealth of the originator on to the document.

The responsibility for a document what ever its content may be naturally rests on the Originator once he affixes his SIGNATURE on it.

All documents will carry a content, which possibly could be altered without leaving any clear trace of alteration noticeable by human eye, this becomes a case of the original itself being tampered with and mostly could be noticed by an expert and with special equipment available for the purpose.

Another recent and easier and almost foolproof method is by using the latest advancement in scanning and copying techniques to selectively alter the contents and also super impose signatures.

Another misuse of documents is the passing of copies of original as original document.

Coming to the point of which portion of the document does a person invariably look to identify an original or a copy or a fake and also assign importance to the document, Every one will agree that one portion of the document which every one's eye focus more than any portion of the document will be the SIGNATURE.

So keeping the above mentioned requirements ideal situation will be to find a means by which the signature of the originator will be on a background which will be of a color & pattern which will be universally understood easily and when the document gets copied or reproduced by other means the color and pattern of the above mentioned background will change without affecting the clarity of the signature on it.

It will be most Ideal when this background could easily be applied and also have the flexibility to be applied at the point of the end of the document (which may be at any portion of the paper) where normally a signature will be located.

It will be still more Ideal if the background itself is applied by the concerned person signing the document so that he will be the one to have the power of deciding which document will require such security of being copy able with clarity but needs to be distinctly differentiated from the original.

Here it can be mentioned that if the originator of the document or so desires or decides that there are certain definite words sentences or characters in the document which needs as much security as the signature than these could also have the above mentioned back ground and those words, sentences or characters can be hand written on the mentioned background by the originator.

Even a more ideal situation will be when the originator who under all circumstances needs to have a pen to sign the document also uses the same pen with ease to create this background whenever the originator so chooses.

A still more ideal situation will be when the background layer is created using an unique and Prestigious material which has universally recognizable colour and texture and uniformity of the same controlled and regulated by one universal body such as the World gold council, The material which will also add literally “value” to the document and add more reason for preserving the same, and a material uniquely qualified to leave a lasting impression will naturally be Gold, The original metallic colour of say 22 carat cannot be copied by any of the present colour photocopying and other present or future process expected to be developed.

Add to this the possibility of Miniature emblems or other marks being simultaneously embossed on to the surface as this golden background is being applied, which again will show-up on the copies distinctly as contrast to the changed colour of the original gold coating background on the original document, add to this the possibility of every individual applying this background with a unique pattern of his own depending on how the person chooses to hold the pen as well as make the strokes, in fact the background will be as unique and individualistic as the signature itself.

After all there is a trend of people in power and people of wealth carrying very costly and exclusive pens for signing documents etc, even though unfortunately at present there is no way an exclusive pen can leave its mark on the signature, So a $10,000 pen or a $1 pen will leave an identical signature of ink on the paper.

Any Document of any significance will naturally have a sufficiently built-in worth and so no one will mind spending say a few dollars of gold paste to create a special background layer for the signature which will greatly enhance the Uniqueness and Security of that document.

### STATEMENT OF INVENTION

This invention relates to a writing Pen with built-in facility to create an embossed and metallic coated under-layer for signature, to secure originality. The pen is provided at the rear end with roller cartridge arrangement in the form of a cartridge, which is attached/connected in any conventional manner to the body of the pen. This cartridge houses the coating substance in a replaceable sub-cartridge and a roller arrangement. The coating substance is a paste made of metal such as gold, which has appropriate qualities to ensure quick drying, non-peeling, clarity and compatibility with ink signature and is provided in a container in the form of a replaceable sub cartridge inside the main cartridge. The main cartridge is a cylinder made of suitable material housing an assembly of embossing cum coating roller arrangement and a means to store and uniformly supply the coating substance to the coating roller. The replaceable cartridge is a cylinder made of suitable substance of suitable dimension to be attached in any conventional form inside the main cartridge and to store the coating substance. The roller arrangement consists of a main embossing and metal coating roller, an intermediate roller and an out feeding roller situated in the cartridge such that they are in radial contact in succession. The main embossing and metal coating roller is made of wear resistant hard material with characters or symbols engraved on the periphery and comes in contact with the paper to create miniature embossed symbols or character. The intermediate roller is made of flexible material such as Vulcan rubber, which transfers the coating substance from the out feeding roller to the main embossing and metal coating roller uniformly. The out feeding roller is made of a suitable metal, which transfers the coating substance from the replaceable sub cartridge to the intermediate roller.

### DESCRIPTION OF THE DRAWINGS

FIG. 1: shows the writing Pen with Built-in facility to create an embossed and metal coated under-layer for signature, to Secure originality. Numeral 9, is the normal writing end of the pen. The main body 10, of the pen is shown having the built-in facility in the form of a metal cartridge 11, situated at the non-writing end.

FIG. 2: shows the cross sectional view of the metal cartridge 11. a portion of the non-writing end of the main body 10 of the pen is also shown in cross section giving a clear picture of the threads 19 used for fixing of the cartridge 11 to the main body 10 of the pen. In this FIG. 2, the cartridge 11 is shown with its cap 12 removed. The cartridge 11 is made up a cylindrical housing 18, (which houses various parts inside it) and the cap 12, not shown in this Figure. Numeral 14 is the main embossing and metal coating roller which projects out of the housing 18, Numeral 15 is the Intermediate roller made of flexible material such as valculon rubber etc. Numeral 17 is the Sub- cartridge containing the metal paste along with the metal paste out-feeding roller 16. the three rollers 14, 15 and 16 are situated such that they are in radial contact in succession. the gear-train 20 interlinks the three above mentioned rollers.

When the main roller 14, is made to roll on the paper in the form of a pen stroke, it applies a fast drying thin coat of metal paste along with an embossing effect caused by the miniature projections 21 in the form of symbols, etc. these projections 21 also cause positive rolling movement of the roller 14, which in turn will cause the gear-train 20 to function causing the intermediate roller 15, as well as the metal paste out-feeding roller 16 of the sub-cartridge 17 to rotate in a relative rotary movement transferring the metal paste progressively on to the paper.

FIG. 3: shows the metal cartridge 11 along with some portion of the pen body 10 in the form of a cross sectional view in a different plane of the arrangement, the cap 12 in cross section can be clearly seen in this Figure.

FIG. 4: shows the enlarged two views of the main roller 14 and the miniature projections 21 on this roller which will cause the embossing effect on paper. This figure also shows in a representative manner the shapes possible for this miniature projections to leave an exclusive type of embossing on paper as required.

FIG. 5: shows the sub-cartridge 17 along with the metal paste out-feeding roller 16 and its, part of the gear-train 20, The sub-cartridge 17 as already explained above will contain the appropriate metal paste with self ejecting arrangement and will out feed the metal paste as required by means of the roller 16 mentioned above.

FIG. 6: shows a representative picture of the metal coated and embossed under layer 22, on paper.

FIG. 7: shows in representative way the appearance of a signature 23, made on the embossed and metal coated under layer.

FIG. 8: shows in a representative manner that various individualistic patterns as required can be created while applying the embossed and metal coated under-layer on paper by use of appropriate pen strokes by the user.

FIG. 9: shows the same cross-section as in FIG. 2, but with the embossing cum coating roller Numeral 14 having projections in the form of numerals and letters instead of symbols.

FIG. 10: shows a representative picture of the metal coated embossed under layer 22 on paper as in FIG. 6, but the embossed under layer having miniature embossed characters in the form of a series of letters and numbers.

FIG. 11: shows in a representative manner the appearance of a signature 23, made on the embossed and metal coated under layer 22, as shown and described in FIG. 10.

FIG. 12: shows the enlarged two views of the embossing cum coating roller as in FIG. 4, but with the projections on the roller being in the form a series of numbers and letters instead of symbols as given in FIG. 4.

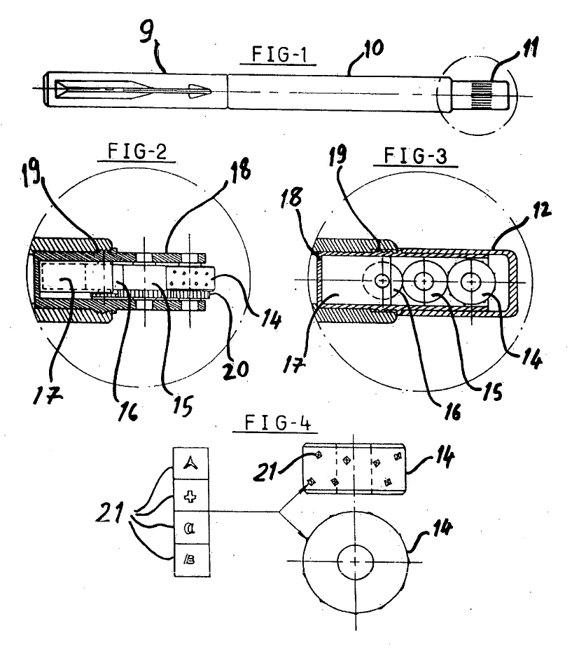

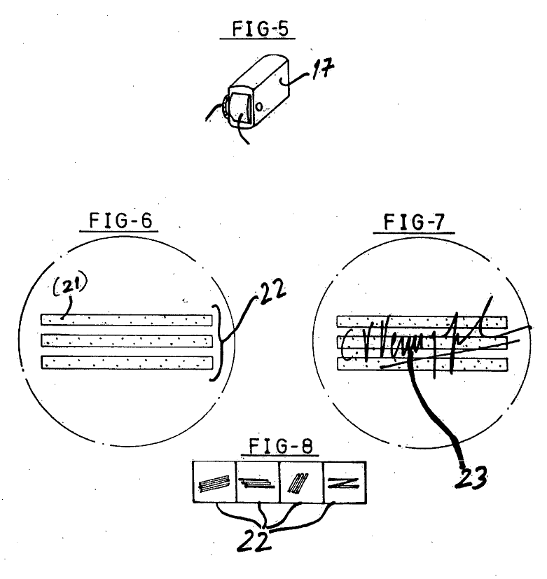

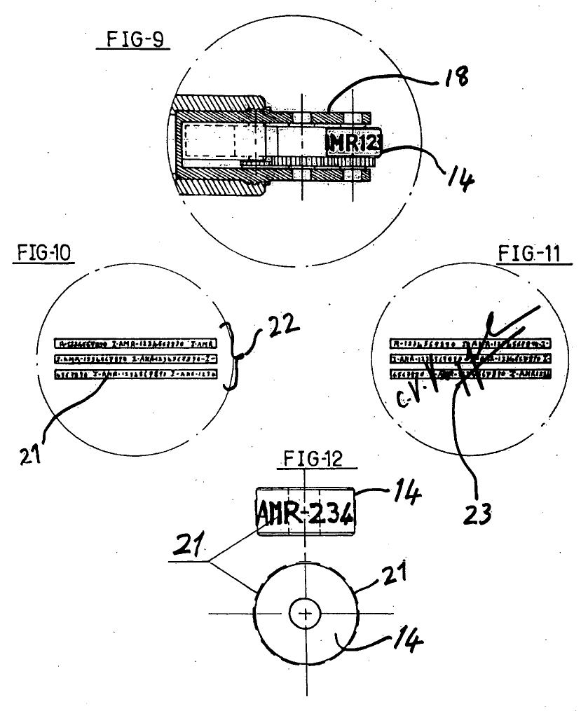

I claim:

1. A writing Pen with built-in facility to create an embossed and metallic coated under-layer for signature, to secure originality, provided at the rear end with roller cartridge arrangement in the form of a cartridge which is attached/connected in any conventional manner to the body of the pen and houses the coating substance, made of a paste comprising any metal such as but not restricted to gold, in a replaceable sub-cartridge and a roller arrangement which consists of a gear mechanism and a main embossing and metal coating roller, an intermediate roller and an out feeding roller which is built into and protruding out of the replaceable sub-cartridge, which when the rear end of the pen is pressed and moved over a paper will produce on it a uniform and quick drying band of coating substance containing miniature embossed symbols or characters.

2. A writing Pen with built-in facility to create an embossed and metallic coated under-layer for signature, to secure originality as claimed in claim 1, wherein the coating substance is a paste made of metal such as but not restricted to gold or other appropriate metals or alloy which has appropriate qualities to ensure quick drying, non-peeling, clarity and compatibility with ink signature and is provided in a container in the form of a replaceable sub cartridge inside the main cartridge.

3. A writing Pen with built-in facility to create an embossed and metallic coated under-layer for signature, to secure originality as claimed in claim 1, wherein the main cartridge is a cylinder made of suitable material housing an assembly of embossing cum coating roller arrangement and a means to store and uniformly supply the coating substance to the coating roller.

4. A writing Pen with built-in facility to create an embossed and metallic coated under-layer for signature, to secure originality as claimed in claim 1, wherein the replaceable cartridge is a container made of suitable substance of suitable dimensions to be attached in any conventional form inside the main cartridge and stores the coating substance.

5. A writing Pen with built-in facility to create an embossed and metallic coated under-layer for signature, to secure originality as claimed in claim 1, wherein the roller arrangement consists of a main embossing and metal coating roller, an intermediate roller and an out feeding roller situated in the cartridge such that they are in radial contact in succession to each other and each rollers have their independent gears in mesh with each other to form a gear mechanism which enables the transfer of rotating motion of the main embossing and metal coating roller to the intermediate roller and the out feeding roller ensuring the uniform transfer of coating substance from the sub cartridge to the main embossing and metal coating roller when it is moved over paper.

6. A writing Pen with built-in facility to create an embossed and metallic coated under-layer for signature, to secure originality as claimed in claim 1, wherein the main embossing and metal coating roller is made of wear resistant hard material with characters or symbols engraved on the periphery and comes in contact with the paper to create miniature embossed symbols or characters.

7. A writing Pen with built-in facility to create an embossed and metallic coated under-layer for signature, to secure originality as claimed in claim 1, wherein the intermediate roller is made of flexible material such as Vulcan rubber which transfers the coating substance from the out feeding roller to the main embossing and metal coating roller uniformly.

8. A writing Pen with built-in facility to create an embossed and metallic coated under-layer for signature, to secure originality as claimed in claim 1, wherein the out feeding roller is built into and protrudes out of the replaceable sub-cartridge and is made of a suitable metal, which transfers the coating substance from the replaceable sub cartridge to the intermediate roller.

9. A writing Pen with built-in facility to create an embossed and metallic coated under-layer for signature, to secure originality as substantially herein described and as illustrated in the accompanying drawings.
